(19) United States
(12) Patent Application Publication
(10) Pub. No.: US 2007/0251545 A1
(43) Pub. Date: Nov. 1, 2007

(54) Kit Consisting of a Sponge and a Detergent

(75) Inventors: Michael Dreja, Koln (DE); Daniela Poethkow, Krefeld (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/597,449

(22) PCT Filed: May 6, 2005
(86) PCT No.: PCT/EP05/04940

§ 371 Date: Dec. 27, 2006

(30) Foreign Application Priority Data
May 24, 2004 (DE) 10 2004 025 859.7

(51) Int. Cl. A47L 13/17; C11D 17/04

(52) U.S. Cl. 134/15; 134/34; 134/42; 510/404; 510/406; 510/461; 510/493; 510/505; 510/506

(57) ABSTRACT

Kits comprising a melamine/formaldehyde resin sponge and a detergent composition comprising: (i) a surfactant selected from the group consisting of anionic surfactants, nonionic surfactants and combinations thereof; and (ii) a C₁₋₆ mono- or poly-hydric alcohol, are described along with methods for cleaning hard surfaces therewith.

The present application relates to a kit consisting of a sponge made of melamine-formaldehyde resin and an aqueous detergent for hard surfaces which comprises anionic and/or nonionic surfactant, and one or more mono- or polyhydric C₁₋₆-alcohols. This kit can be used for cleaning hard surfaces; in the corresponding cleaning method, the composition is placed either onto the cleaning sponge or directly onto the surface to be cleaned and rubbed into the surface with the sponge before the composition finally dries or is rinsed off with water. If appropriate, the surface can then be buffed with a dry cloth.

For cleaning hard surfaces, surfactant-containing and thus soil-removing detergents have proven useful. These compositions can be applied to the area to be cleaned and spread thereon using brushes, cloths, sponges and other suitable aids, where, if appropriate, an additional mechanical treatment also takes place which leads to an improved cleaning result.

In recent times, special cleaning sponges have also been used which are simply wetted with water and can then be used for cleaning hard surfaces. These are essentially sponges made of a melamine-formaldehyde resin. The use of this material, which is sold, for example, under the name Basotect® by BASF, for cleaning hard surfaces has already been described on more than one occasion. Thus, DE 100 27 770 A1 (BASF) and EP 0 176 72 B1 (BASF) describe elastic, open-cell foams made of melamine/formaldehyde condensation products, methods for their production, and their use. The foams are primarily intended for use in thermal insulation and soundproofing in construction, although it is also stated that they are also suitable as cleaning sponges with a slightly abrasive action. Further details on this intended use, however, are not given.

The utility model specification DE 201 09 652 U1 (K. Matsumoto) describes a cleaning sponge made of a melamine-formaldehyde resin foam whose cell structure is compressed, as a result of which the foam becomes more durable and thus can also be better used as a cleaning sponge. Further details on actual use during cleaning, however, are not given.

U.S. Pat. No. 6,503,615 B1 (Inoac Corp.) also describes a cleaning sponge made of melamine-formaldehyde resin. This additionally comprises an anionic surfactant which is used during manufacture as emulsifier and remains in the sponge in order to improve the cleaning power when used for cleaning. Use with an additional detergent specifically matched to the cleaning sponge, on the other hand, is not described.

When cleaning hard surfaces with such sponges, good results can be achieved in the case of dry soilings containing little grease, for example when removing felt-pen from plastic surfaces or ballpoint pen ink from wallpaper. To remove fresh or stubborn burnt-on grease soiling, on the other hand, the material is only of limited suitability since the pores stick together and an abrasive action is no longer possible. Even with the help of water, cleaning is not improved significantly.

The good cleaning effect of the melamine-formaldehyde resin Basotect® in the case of dry soilings containing little grease is to be attributed to the specific open-pored structure of the material, which has notable abrasivity, and which is renewed through abrasion. In the case of greasy soiling, on the other hand, the pores stick together, meaning that an abrasive action is no longer possible.

It was therefore desirable to extend the usability of such sponge cleaners to include greasy soilings. Surprisingly, it has now been found that when using a detergent which comprises anionic and/or nonionic surfactant and also one or more mono- or polyhydric C₁₋₆-alcohols together with a sponge made of melamine-formaldehyde resin, even burnt-on greasy soiling is removed easily and completely whereas when the sponge is used merely with water or when using the detergent with a different type of sponge, the greasy soiling can only be removed to a small extent, if at all.

Accordingly, the application provides a kit consisting of a sponge made of a melamine-formaldehyde resin and an aqueous detergent for hard surfaces which comprises anionic and/or nonionic surfactant, and one or more mono- or polyhydric C₁₋₆-alchols.

This kit serves for the cleaning of hard surfaces and can therefore be used in a method for cleaning hard surfaces. Consequently, the application secondly provides the use of a kit consisting of a sponge made of a melamine-formaldehyde resin and an aqueous detergent for hard surfaces which comprises anionic and/or nonionic surfactant, and one or more mono- or polyhydric C₁₋₆-alcohols for cleaning hard surfaces. A third subject matter is a method of cleaning hard surfaces, in particular for removing greasy soiling, using such a kit, in which firstly the liquid aqueous detergent from the kit is applied to the surface to be cleaned and then the sponge from the kit is used to spread and, if appropriate, to rub the composition, where the composition and any dissolved soiling can then optionally be rinsed off with water. The sponge can also be impregnated or supplied with a detergent, which gives rise to yet a further subject matter of the invention. Finally, the application still further provides a method of cleaning hard surfaces, in particular for removing greasy soiling, using such a kit, in which firstly the liquid aqueous detergent from the kit is applied to the sponge from the kit, the more or less saturated sponge is then brought into contact with the surface to be cleaned and the surface is cleaned by gentle rubbing before, in a last, optional step, the composition and any dissolved soiling can be rinsed off with water.

Sponge

The sponge material used is a melamine/formaldehyde resin foam. Melamine/formaldehyde resin is a condensation product of melamine and, if appropriate, further thermoset formers and formaldehyde and, if appropriate, further aldehydes. Thermoset formers which may be used here are, for example, alkyl-substituted melamine, urea, urethanes, carboxamides, dicyandiamide, guanidine, sulfurylamide, sulfonamides, aliphatic amines, phenol and derivatives thereof, suitable aldehydes are, for example, acetaldehyde, trimethylolacetaldehyde, acrolein, benzaldehyde, furfural, glyoxal, glutaraldehyde, phthalaldehyde and terephthalaldehyde. The precondensate obtained from the monomers is foamed using a propellant and then cured. This produces an open-pored material with a foam structure, the average pore sizes (more accurately: average distances between ridges of the foam lamellae) are between about 10 μm and 400 μm. The foam is available, for example, under the trade name Basotect® from BASF and is used primarily as thermal insulation and soundproofing in the building sector. For the purposes of this invention, the foamed melamine/formaldehyde resin is used as cleaning sponge for hard surfaces with a slightly abrasive action.

Detergent

The second constituent of the kit according to the invention is a detergent for hard surfaces. This comprises anionic and/or nonionic surfactant, and one or more mono- or polyhydric C₁₋₆-alcohols. In addition, octyl sulfate is preferably present.

Fatty acids and further ingredients customary in detergents may also be present.

For the purposes of the present invention, fatty acids and fatty alcohols and derivatives thereof—unless stated otherwise—are representative of branched or unbranched carboxylic acids and alcohols and derivatives thereof having preferably 6 to 22 carbon atoms. The former are preferred for ecological reasons on account of their being vegetable-based and based on renewable raw materials, without, however, limiting the teaching according to the invention thereto. In particular, the oxo alcohols obtainable, for example, by the ROELEN oxo synthesis, and derivatives thereof, can also be used accordingly.

In the text below, whenever alkaline earth metals are specified as counterions for monovalent anions, this means that the alkaline earth metal is naturally only present in half the quantitative amount—sufficient for balancing the charge—as the anion.

Substances which also serve as ingredients of cosmetic compositions are sometimes referred to below in accordance with the International Nomenclature Cosmetic Ingredient (INCI) nomenclature. Chemical compounds bear an INCI name in English, vegetable ingredients are listed exclusively in accordance with Linné in Latin. So-called trivial names such as “water”, “honey” or “sea salt” are likewise given in Latin. The INCI names can be found in the “International Cosmetic Ingredient Dictionary and Handbook, Seventh Edition (1997)”, which is published by The Cosmetic, Toiletry and Fragrance Association (CTFA), 1101, 17^{th} Street NW, Suite 300, Washington, D.C. 20036, U.S.A., and contains more than 9 000 INCI names and cross references to more than 37 000 trade names and technical names including the relevant distributors from more than 31 countries. The International Cosmetic Ingredient Dictionary and Handbook assigns the ingredients to one or more Chemical Classes, for example “Polymeric Ethers”, and to one or more Functions, for example “Surfactants—Cleansing Agents”, which it explains in turn in more detail. Where appropriate, reference is likewise made to this below.

The designation CAS means that the following numerical sequence is a Chemical Abstracts Service notation. Unless explicitly stated otherwise, amounts specified in percent by weight (% by wt.) refer to the total surfactant combination or the total composition.

Surfactants

Nonionic Surfactants

Nonionic surfactants to be mentioned are primarily C₈-C₁₈-alcohol polyglycol ethers, i.e. ethoxylated and/or propoxylated alcohols having 8 to 18 carbon atoms in the alkyl moiety and 2 to 15 ethylene oxide (EO) and/or propylene oxide units (PO), C₈-C₁₈-carboxylic acid polyglycol esters with 2 to 15 EO, for example tallow fatty acid+6 EO ester, ethoxylated fatty acid amides having 12 to 18 carbon atoms in the fatty acid moiety and 2 to 8 EO, long-chain amine oxides having 10 to 20 carbon atoms and long-chain alkyl polyglycosides having 8 to 14 carbon atoms in the alkyl moiety and 1 to 3 glycoside units. Examples of such surfactants are oleyl-cetyl alcohol with 5 EO, nonylphenol with 10 EO, lauric acid diethanolamide, cocoalkyldimethylamine oxide and cocoalkyl polyglucoside with, on average, 1.4 glucose units. Particular preference is given to fatty alcohol polyglycol ethers with in particular 2 to 10 EO, in particular a C₁₂-fatty alcohol ethoxylate with 7 EO. In addition, however, it is also possible to use short-chain alcohol polyglycol ethers, i.e. those with a C₄-C₈ carbon chain and preferably fewer than 10 EO, for example C₆-alcohol polyglycol ethers with 5 EO. Further suitable nonionic surfactants are the C₈-C₁₈-amine oxides and, among these, preference is given to those with a C₁₂-C₁₄ chain, such as lauryidimethylamine oxide, which is sold, for example, under the trade names Genaminox LA (Clariant) or Standamox PL (Cognis).

C₈-C₁₈-Alkyl alcohol polypropylene glycol/polyethylene glycol ethers are preferred known nonionic surfactants. They can be described by formula I, R^{I}O—(CH₂CH(CH₃)O)ₚ(CH₂CH₂O)ₑ—H, in which R^{I} is a linear or branched, aliphatic alkyl and/or alkenyl radical having 8 to 18 carbon atoms, p is 0 or numbers from 1 to 3 and e is numbers from 1 to 20.

The C₈-C₁₈-alkyl alcohol polyglycol ethers of formula I can be obtained by adding propylene oxide and/or ethylene oxide onto alkyl alcohols, preferably onto fatty alcohols. Typical examples are polyglycol ethers of the formula I in which R^{I} is an alkyl radical having 8 to 18 carbon atoms, p is 0 to 2 and e is numbers from 2 to 7. Preferred representatives are, for example, C₁₀-C₁₄-fatty alcohol+1PO+6EO ethers (p=1, e=6) and C₁₂-C₁₈-fatty alcohol+7EO ethers (p=0, e=7), and mixtures thereof. If a cleaning paste is to be formulated with which the sponge according to the invention is supplied, a more highly ethoxylated fatty alcohol polyglycol ether may also be used, for example C₁₆-C₁₈-fatty alcohol+25 EO ether.

It is also possible to use terminally capped C₈-C₁₈-alkyl alcohol polyglycol ethers, i.e. compounds in which the free OH group in formula I is etherified. The terminally capped C₈-C₁₈-alkyl alcohol polyglycol ethers can be obtained by relevant methods of preparative organic chemistry. Preferably, C₈-C₁₈-alkyl alcohol polyglycol ethers are treated with alkyl halides, in particular butyl chloride or benzyl chloride in the presence of bases. Typical examples are mixed ethers of the formula I in which R^{I} is a technical-grade fatty alcohol radical, preferably C_{12/14}-cocoalkyl radical, p is 0 and e is 5 to 10, which are capped with a butyl group.

Preferred nonionic surfactants are also alkyl polyglycosides (APG) of the formula II, R^{II} O [G]ₓ, in which R^{II} is a linear or branched, saturated or unsaturated alkyl radical having 8 to 22 carbon atoms, [G] is a glycosidically linked sugar radical and x is a number from 1 to 10. APGs are nonionic surfactants and are known substances which can be obtained by the appropriate methods of preparative organic chemistry. The index number x in the general formula II indicates the degree of oligomerization (degree of DP), i.e. the distribution of mono- and oligoglycosides, and is a number between 1 and 10. Whereas x in a given compound must always be an integer and here can primarily assume the values x=1 to 6, the value x for a certain alkyl glycoside is an analytically determined calculated quantity, which in most cases is a fractional number. Preference is given to using alkyl glycosides with an average degree of oligomerization x of from 1.1 to 3.0. From the point of view of application, preference is given to those alkyl glycosides whose degree of oligomerization is less than 1.7 and in particular is between 1.2 and 1.6. The glycosidic sugar used is preferably xylose, but in particular glucose.

The alkyl or alkenyl radical R^{II} (formula II) can be derived from primary alcohols having 8 to 18, preferably 8 to 14, carbon atoms. Typical examples are caproic alcohol, capryl alcohol, capric alcohol and undecyl alcohol, and technical-grade mixtures thereof, as are produced, for example, in the course of the hydrogenation of technical-grade fatty acid methyl esters or in the course of the hydrogenation of aldehydes from the ROELEN oxo synthesis.

Preferably, the alkyl or alkenyl radical R^{II}, however, is derived from lauryl alcohol, myristyl alcohol, cetyl alcohol, palmoleyl alcohol, stearyl alcohol, isostearyl alcohol or oleyl alcohol. In addition, elaidyl alcohol, petroselinyl alcohol, arachidyl alcohol, gadoleyl alcohol, behenyl alcohol, erucyl alcohol, and technical-grade mixtures thereof are to be mentioned.

Further nonionic surfactants which may be present are nitrogen-containing surfactants, e.g. fatty acid polyhydroxamides, for example glucamides, and ethoxylates of alkylamines, vicinal diols and/or carboxamides which have alkyl groups having 10 to 22 carbon atoms, preferably 12 to 18 carbon atoms. Here, the degree of ethoxylation of these compounds is generally between 1 and 20, preferably between 3 and 10. Preference is given to ethanolamide derivatives of alkanoic acids having 8 to 22 carbon atoms, preferably 12 to 16 carbon atoms. Particularly suitable compounds include the lauric acid, myristic acid and palmitic acid monoethanolamides.

Anionic Surfactants

Suitable anionic surfactants are preferably C₈-C₁₈-alkylbenzenesulfonates, in particular having about 12 carbon atoms in the alkyl moiety, C₈-C₂₀-alkanesulfonates, C₈-C₁₈-monoalkyl sulfates, C₈-C₁₈-alkyl polyglycol ether sulfates with 2 to 6 ethylene oxide units (EO) in the ether moiety, and sulfosuccinic acid mono- and di-C₈-C₁₈-alkyl esters. In addition, C₈-C₁₈-α-olefinsulfonates, sulfonated C₈-C₁₈-fatty acids, in particular dodecylbenzenesulfonate, C₈-C₂₂-carboxamide ether sulfates, C₈-C₁₈-alkyl polyglycol ether carboxylates, C₈-C₁₈-N-acyl taurides, C₈-C₁₈-N-sarcosinates and C₈-C₁₈-alkyl isothionates and mixtures thereof can also be used.

The anionic surfactants are preferably used as sodium salts, but can also be present as other alkali metal or alkaline earth metal salts, for example magnesium salts, and in the form of ammonium or mono-, di-, tri- or tetraalkylammonium salts, in the case of the sulfonates also in the form of their corresponding acid, e.g. dodecylbenzenesulfonic acid.

Examples of such surfactants are sodium cocoalkyl sulfate, sodium sec-alkanesulfonate with about 15 carbon atoms, and sodium dioctyl sulfosuccinate. Sodium fatty alkylsulfates and sodium fatty alkyl+2 EO ether sulfates having 12 to 14 carbon atoms have proven to be particularly suitable. Very particular preference, however, is given to sodium salts of alkylbenzenesulfonic acids; a further particularly preferred anionic surfactant is octyl sulfate.

C₁₋₆ Alcohol

In addition, the detergent according to the invention also comprises one or more mono- or polyhydric C₁₋₆ alcohols.

Examples of alcohols which can be used according to the invention are the following compounds named according to INCI: Alcohol (Ethanol), n-Butyl Alcohol, t-Butyl Alcohol, Butylene Glycol, Diethylene Glycol, Dipropylene Glycol, Glycol, Hexanediol, 1,2,6-Hexanetriol, Hexyl Alcohol, Hexylene Glycol, Isopentyldiol, Isopropyl Alcohol (iso-Propanol), Methyl Alcohol, Methylpropanediol, Neopentyl Glycol, Pentylene Glycol, Propanediol, Propyl Alcohol (n-Propanol), Propylene Glycol. Preferably, the alcohol here is chosen from the group comprising methanol, ethanol, isopropanal, n-propanol, n-butanol, ethanediol, propanediol, and mixtures thereof, particularly preferably ethanol and isopropanol, in particular ethanol.

Glycol ethers (ether alcohols) may also be present in detergents according to the invention. Of suitability here are adequately water-soluble compounds having up to 10 carbon atoms in the molecule. Examples of such ether alcohols are ethylene glycol monobutyl ether (butyl glycol), propylene glycol monobutyl ether, diethylene glycol monobutyl ether, propylene glycol mono-tertiary-butyl ether, propylene glycol hexyl ether and propylene glycol monoethyl ether, of these preference in turn being given to ethylene glycol monobutyl ether and propylene glycol monobutyl ether.

The detergent according to the invention can also comprise one or more fatty acids in amounts of from 0.1 to 2% by weight. Fatty acids which can be used here are, in particular, those with a chain length of from C₈ to C₁₈.

Besides the surfactant types mentioned hitherto, the composition according to the invention can in addition also comprise cationic surfactants and/or amphoteric surfactants.

Suitable amphoteric surfactants are, for example, betaines of the formula (R^{III})(R^{IV})(R^{V})N⁺CH₂COO⁻, in which R^{III} is an alkyl radical having 8 to 25, preferably 10 to 21, carbon atoms optionally interrupted by heteroatoms or heteroatom groups, and R^{IV} and R^{V} are similar or different alkyl radicals having 1 to 3 carbon atoms, in particular C₁₀-C₁₈-alkyldimethylcarboxymethylbetaine and C₁₁-C₁₇-alkylamidopropyldimethylcarboxymethylbetaine. The compositions comprise amphoteric surfactants in amounts, based on the composition, of from 0 to 10% by weight.

Suitable cationic surfactants are, inter alia, the quaternary ammonium compounds of the formula (R^{VI})(R^{VII})(R^{VIII})(R^{IX})N⁺ X⁻, in which R^{VI} to R^{IX} are four similar or different, in particular two long-chain and two short-chain, alkyl radicals, and X⁻ is an anion, in particular a halide ion, for example didecyidimethylammonium chloride, alkylbenzyldidecylammonium chloride and mixtures thereof. The compositions comprise cationic surfactants in amounts, based on the composition, of from 0 to 10% by weight.

Besides the components mentioned hitherto, the aqueous detergent according to the invention can comprise further ingredients customary in detergents. These include, in particular, bases, acids, viscosity regulators, dyes, fragrances, preservatives, disinfectants, complexing agents for alkaline earth metal ions, enzymes, abrasives, electrolytes, fillers, bleach systems, and agents for surface modification.

Bases

The bases used in compositions according to the invention are preferably those from the group of alkali metal and alkaline earth metal hydroxides and carbonates, in particular sodium carbonate or sodium hydroxide. In addition, however, it is also possible to use ammonia and/or alkanolamines having up to 9 carbon atoms in the molecule, preferably the ethanolamines, in particular monoethanolamine. The content of bases is preferably 0 to 3% by weight, in particular 0.01 to 2% by weight.

Acids

Compositions according to the invention can additionally comprise acids. Suitable acids are, in particular, organic acids, such as the carboxylic acids formic acid, acetic acid, glycolic acid, lactic acid, citric acid, succinic acid, adipic acid, malic acid, tartaric acid and gluconic acid, or else amidosulfonic acid. Of these, citric acid is particularly preferred. In addition, however, it is also possible to use the mineral acids hydrochloric acid, sulfuric acid and nitric acid, and mixtures thereof. The content of acids is preferably 0 to 15% by weight, in particular 0.1 to 12% by weight.

Viscosity Regulators

Suitable viscosity regulators are, for example, organic natural thickeners (agar-agar, carrageen, tragacanth, gum Arabic, alginates, pectins, polyoses, guar flour, carob seed flour, starch, cellulose, dextrins, gelatin, casein), organically modified natural substances (carboxymethylcellulose and other cellulose ethers, hydroxyethylcellulose and hydroxypropylcellulose and the like, seed flour ether), completely synthetic organic thickeners (polyacrylic and polymethacrylic compounds, vinyl polymers, polycarboxylic acids, polyethers, polyimines, polyamides) and inorganic thickeners (polysilicic acids, clay minerals, such as montmorillonites, zeolites, silicas).

The polyacrylic and polymethacrylic compounds include, for example, the high molecular weight homopolymers of acrylic acid crosslinked with a polyalkenyl polyether, in particular an allyl ether of sucrose, pentaerythritol or propylene (INCI name according to International Dictionary of Cosmetic Ingredients of The Cosmetic, Toiletry and Fragrance Association (CTFA): Carbomer), which are also referred to as carboxyvinylpolymers. Such polyacrylic acids are obtainable, inter alia, from 3V Sigma under the trade name Polygel®, e.g. Polygel® DA, and from BF Goodrich under the trade name Carbopol®, e.g. Carbopol® 940 (molecular weight about 4 000 000), Carbopol® 941 (molecular weight about 1 250 000) or Carbopol® 934 (molecular weight about 3 000 000). The following acrylic acid copolymers are also included: (i) copolymers of two or more monomers from the group of acrylic acid, methacrylic acid and their monoesters, preferably formed with C₁₋₄-alkanols, (INCI Acrylates Copolymer), which include, for example, the copolymers of methacrylic acid, butyl acrylate and methyl methacrylate (CAS name according to Chemical Abstracts Service: 25035-69-2) or of butyl acrylate and methyl methacrylate (CAS 25852-37-3) and which are obtainable, for example, from Rohm & Haas under the trade names Aculyn® and Acusol®, and from Degussa (Goldschmidt) under the trade name Tego® Polymer, e.g. the anionic nonassociative polymers Aculyn® 22, Aculyn® 28, Aculyn® 33 (crosslinked), Acusol® 810, Acusol® 823 and Acusol® 830 (CAS 25852-37-3); (ii) crosslinked high molecular weight acrylic acid copolymers, including, for example, the copolymers of C₁₀₋₃₀-alkyl acrylates, crosslinked with an allyl ether of sucrose or of pentaerythritol, with one or more monomers from the group of acrylic acid, methacrylic acid and their monoesters preferably formed with C₁₋₄-alkanols (INCI Acrylates/C10-30 Alkyl Acrylate Crosspolymer) and which are obtainable, for example, from BF Goodrich under the trade name Carbopol®, e.g. the hydrophobicized Carbopol® ETD 2623 and Carbopol® 1382 (INCI Acrylates/C10-30 Alkyl Acrylate Crosspolymer), and Carbopol® AQUA 30 (previously Carbopol® EX 473). The international application WO 97/38076 lists a series of polymers derived from acrylic acid which are suitable viscosity regulators.

Further thickeners are the polysaccharides and heteropolysaccharides, in particular the polysaccharide gums, for example gum Arabic, agar, alginates, carrageens and their salts, guar, guaran, tragacanth, gellan, ramsan, dextran or xanthan and their derivatives, e.g. propoxylated guar, and their mixtures. Other polysaccharide thickeners, such as starches or cellulose or cellulose derivatives, can be used alternatively, but preferably in addition to a polysaccharide gum, for example starches of very diverse origin and starch derivatives, e.g. hydroxyethyl starch, starch phosphate ester or starch acetates, or carboxymethylcellulose or its sodium salt, methyl-, ethyl-, hydroxyethyl-, hydroxypropyl-, hydroxypropylmethyl- or hydroxyethylmethylcellulose or cellulose acetate. A particularly preferred polysaccharide thickener is the microbial anionic heteropolysaccharide xanthan gum which is produced by Xanthomonas campestris and a few other species under aerobic conditions with a molecular weight of 2-15×10⁶ and is available, for example, from Kelco under the trade names Keltrol® and Kelzan® or from Rhodia under the trade name Rhodopol®.

Sheet silicates can also be used as thickeners. They include, for example, the magnesium or sodium-magnesium sheet silicates obtainable under the trade name Laponite® from Solvay Alkali, in particular Laponite® RD or Laponite® RDS, and the magnesium silicates from Süd-Chemie, especially Optigel® SH.

Antimicrobial Active Ingredients

A particular form of cleaning is disinfection and sanitation. In a corresponding particular embodiment of the invention, the detergent therefore comprises one or more antimicrobially active ingredients. For the purposes of the teaching according to the invention, the terms disinfection, sanitation, antimicrobial effect and antimicrobially active ingredient have the meaning customary in the field, which is given for example, by K. H. Wallhäuβer in “Praxis der Sterilisation, Desinfektion—Konservierung: Keimidentifizierung—Betriebshygiene” [Practice of sterilization, disinfection—preservation: germ identification—occupational hygiene] (5^{th} edition—Stuttgart; New York: Thieme, 1995). Whereas disinfection in the relatively narrow sense of medical practice means the killing of—theoretically all—infection germs, sanitation is understood as meaning the elimination as far as possible of all germs—including saprophytic germs which are normally harmless to humans. Here, the extent of disinfection or sanitation is dependent on the antimicrobial effect of the composition used, which decreases with decreasing content of antimicrobially active ingredient or increasing dilution of the composition for use.

Of suitability according to the invention are, for example, antimicrobially active ingredients from the groups of alcohols, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazoles and derivatives thereof, such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophores and peroxides. Preferred antimicrobially active ingredients are preferably chosen from the group comprising ethanol, n-propanol, isopropanol, 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylenebis(6-bromo4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)bis(1-octanamine)dihydrochloride, N,N′-bis(4-chlorophenyl)-3,12-diimino-2,4,11,13-tetraazotetradecanediimideamide, anti-microbial quaternary surface-active compounds, guanidines. Preferred antimicrobially effective surface-active quaternary compounds contain an ammonium, sulfonium, phosphonium, iodonium or arsonium group, as, for example, K. H. Wallhäuβer describes in “Praxis der Sterilisation, Desinfektion—Konservierung: Keimidentifizierung—Betriebshygiene” [Practice of sterilization, disinfection—preservation: germ identification—occupational hygiene] (₅^{th} edition—Stuttgart; New York: Thieme, 1995). Furthermore, it is also possible to use antimicrobially effective essential oils, which simultaneously provide for scenting of the detergent. Particularly preferred antimicrobially active ingredients, however, are chosen from the group comprising salicylic acid, quaternary surfactants, in particular benzalkonium chloride, peroxo compounds, in particular hydrogen peroxide, alkali metal hypochlorite, and mixtures thereof.

According to the invention, bleaches can also be added to the detergent. Suitable bleaches in acidic detergents include peroxides, peracids and/or perborates, particular preference being given to H₂O₂. A further suitable bleach which has proven particularly useful in detergents that have been rendered alkaline is sodium hypochlorite.

The detergent according to the invention used in the kit can, if desired, be rendered acidic or alkaline depending on the intended use. As alkaline detergent, the composition is here preferably set to a pH of from 8 to 12, in particular pH 9-10. As acidic detergent, the composition, on the other hand, is preferably set to a pH of from 2.5 to 6, in particular pH 4-5.

Kits according to the invention consisting of a sponge and a detergent are used for cleaning hard surfaces. In one embodiment, cleaning sponge and detergent are kept separate until use, so that, during the cleaning process, either the liquid aqueous detergent from the kit is first applied to the surface to be cleaned where it is then spread and, if appropriate, rubbed with the sponge, or else the detergent is first applied to the sponge and the saturated sponge is then brought into contact with the surface to be cleaned, on which the composition is then spread and rubbed. With both process variants, in an optional last step, the composition and any dissolved soiling can then be rinsed off with water.

In a further embodiment, the sponge is impregnated or supplied with the detergent. Besides liquid detergents, paste-like or pulverulent detergents are also suitable here. In the case of liquid compositions in particular, it may be advantageous if the impregnated sponge is given a water-impermeable packaging in order to prevent the sponge from drying out. In one cleaning method, the sponge impregnated or supplied with detergent is, if necessary, wetted with water, particularly if the detergent is pulverulent, and then brought into contact with the surface to be cleaned. The remainder of the method corresponds to the method already described.

### WORKING EXAMPLES

A greasy soiling (98 parts Mazola oil, 2 parts carbon black) was applied to a ceramic floor tile and burnt in at 110° C. for 5 h in a heating oven. The resulting greasy soiling could not be removed using a Spontex sponge (standard commercial cleaning sponge made of viscose) and the detergents E1-E4. Using the sponge made of melamine-formaldehyde resin (Basotect®) contained in the kit according to the invention and water, it was possible to remove only a small amount of the greasy soiling, but when the sponge made of Basotect® was used together with detergents E1-E4, the greasy soiling could be removed easily and virtually completely:

TABLE 1
alkaline detergents (all-purpose, glass, kitchen)

| Composition [% by wt.] | E1 | E2 | E3 | E4 |
|---|---|---|---|---|
| Fatty alcohol ethoxylate C12-7EO | 1 | 3 | 5 | 0.5 |
| Alkylbenzenesulfonic acid Na salt | 3 | 1 | 2 | 4 |
| Octyl sulfate | 3 | 2 | 2 | 2 |
| Sodium carbonate | 1.5 | 0.5 | 1.0 | 1.5 |
| Citric acid | 0.5 | 0.5 | 0.5 | 0.5 |
| Fatty acid | 0.5 | 0.5 | 0.5 | 1.0 |
| Ethanol | 5 | 3 | 5 | 3 |
| Perfume | 0.2 | 0.2 | 0.2 | 0.2 |
| Water | ad 100 | ad 100 | ad 100 | ad 100 |

Together with detergents rendered acidic, as are often used, for example, as sanitary cleaners in the bathroom sector, it is also possible to achieve good cleaning results using the sponge made of Basotect®). Examples of suitable detergents are given in Table 2.

TABLE 2
acidic detergents (bath, toilet)

| Composition [% by wt.] | E5 | E6 | E7 | E8 |
|---|---|---|---|---|
| Fatty alcohol ether sulfate | 2 | 3 | 5 | 2 |
| C12-2EO sodium salt | | | | |
| Ethanol | 3 | 3 | 3 | 3 |
| Citric acid | 3 | 10 | 3 | 10 |
| Thickener xanthan Kelzan ASX-T | — | 0.05 | — | 0.05 |
| Perfume | 0.1 | 0.1 | 0.1 | 0.1 |
| Water | ad 100 | ad 100 | ad 100 | ad 100 |

Good cleaning results are likewise achieved using a sponge made of Basotect® supplied with a cleaning paste or a cleaning powder. Corresponding formulations are given in the tables below:

TABLE 3
cleaning paste

| Composition [% by wt.] | E9 |
|---|---|
| C₁₂ Fatty alcohol sulfate | 20 |
| C₁₆₋₁₈ Fatty alcohol ethoxylate 25 EO | 20 |
| C₁₂₋₁₈ Fatty acid monoethanolamide | 10 |
| Sodium sulfate | 40 |
| Sodium carbonate | 5 |
| Cellulose | 4.899 |
| Dye | 0.001 |
| Perfume | 0.1 |

TABLE 4
self-foaming cleaning powder

| Composition [% by wt.] | E10 |
|---|---|
| C₁₂ Fatty alcohol sulfate | 2 |
| Sodium sulfate | 37899 |
| Sodium carbonate | 25 |
| Citric acid | 35 |
| Dye | 0.001 |
| Perfume | 0.1 |

1-16. (canceled)

17. A kit comprising a melamine/formaldehyde resin sponge and a detergent composition, wherein the detergent composition comprises: (i) a surfactant selected from the group consisting of anionic surfactants, nonionic surfactants and combinations thereof; and (ii) a C₁₋₆ mono- or poly-hydric alcohol.

18. The kit according to claim 17, wherein the detergent composition further comprises octyl sulfate.

19. The kit according to claim 17, wherein the surfactant comprises a nonionic surfactant selected from the group consisting of C₈₋₁₈ fatty alcohol polyglycol ethers having 2 to 15 EO and/or PO groups, C₈₋₁₈ carboxylic acid polyglycol esters having 2 to 15 EO groups, ethoxylated C₁₂₋₁₈ fatty acid amides having 2 to 8 EO groups, C₁₀₋₂₀ amine oxides having 14 to 20 carbon atoms, C₈₋₁₈ alkyl polyglycosides, and mixtures thereof.

20. The kit according to claim 17, wherein the surfactant comprises an anionic surfactant selected from the group consisting of C₈₋₁₈ alkylbenzenesulfonates, C₈₋₂₀ alkanesulfonates, C₈₋₁₈ monoalkyl sulfates, C₈₋₁₈ alkyl polyglycol ether sulfates having 2 to 6 EO groups, sulfosuccinic acid mono- and di-C₈₋₁₈ alkyl esters, C₈₋₁₈-α-olefinsulfonates, sulfonated C₈₋₁₈ fatty acids, C₈₋₂₂ carboxamide ether sulfates, C₈₋₁₈ alkyl polyglycol ether carboxylates, C₈₋₁₈ N-acyl taurides, C₈₋₁₈ N-sarcosinates, C₈₋₁₈ alkyl isothionates, and mixtures thereof.

21. The kit according to claim 17, wherein the C₁₋₆ mono- or poly-hydric alcohol comprises a component selected from the group consisting of methanol, ethanol, isopropanol, n-propanol, n-butanol, ethanediol, propanediol, and mixtures thereof.

22. The kit according to claim 17, wherein the C₁₋₆ mono- or poly-hydric alcohol comprises ethanol.

23. The kit according to claim 17, wherein the detergent composition further comprises one or more fatty acids in an amount of 0.1 to 2% by weight.

24. The kit according to claim 17, wherein the detergent composition has a pH of 8 to 12.

25. The kit according to claim 17, wherein the detergent composition has a pH of 2.5 to 6.

26. The kit according to claim 17, wherein the detergent composition is aqueous and wherein the melamine/formaldehyde resin sponge is impregnated with the aqueous detergent composition.

27. The kit according to claim 26, wherein the impregnated sponge is provided in water-impermeable packaging.

28. The kit according to claim 17, wherein the detergent composition is provided in a form selected from the group consisting of paste detergents, pulverulent detergents and combinations thereof.

29. The kit according to claim 28, wherein the detergent composition is disposed in the sponge.

30. A kit comprising a melamine/formaldehyde resin sponge and an aqueous detergent composition, wherein the detergent composition comprises: (i) a surfactant selected from the group consisting of C₁₀₋₁₈ fatty alcohol ethoxylates having 2 to 10 EO groups, C₈₋₁₈ alkylbenzenesulfonates, and combinations thereof; (ii) ethanol; and (iii) octyl sulfate.

31. A method comprising: (a) providing a hard surface to be cleaned; and (b) contacting the hard surface with a detergent composition and a melamine/formaldehyde resin sponge, wherein the detergent composition comprises (i) a surfactant selected from the group consisting of anionic surfactants, nonionic surfactants and combinations thereof; and (ii) a C₁₋₆ mono- or poly-hydric alcohol.

32. The method according to claim 31, wherein contacting the hard surface with the detergent composition and the melamine/formaldehyde resin sponge comprises applying the detergent composition to the hard surface and spreading the detergent composition on the hard surface with the sponge.

33. The method according to claim 31, wherein contacting the hard surface with the detergent composition and the melamine/formaldehyde resin sponge comprises applying the detergent composition to the sponge and bringing the sponge into contact with the hard surface.

34. The method according to claim 31, wherein the melamine/formaldehyde resin sponge is impregnated with the detergent composition and the detergent composition-impregnated sponge is brought into contact with the hard surface.

35. The method according to claim 31, further comprising a subsequent treatment selected from rubbing the composition on the hard surface with the sponge, rinsing the composition from the hard surface, and a combination thereof.

36. The method according to claim 31, wherein the detergent composition comprises: (i) a surfactant selected from the group consisting of C₁₀₋₁₈ fatty alcohol ethoxylates having 2 to 10 EO groups, C₈₋₁₈ alkylbenzenesulfonates, and combinations thereof; (ii) ethanol; and (iii) octyl sulfate.
